(19) United States
(12) Patent Application Publication
(10) Pub. No.: US 2021/0170675 A1
(43) Pub. Date: Jun. 10, 2021

(54) STEREOLITHOGRAPHY APPARATUS EQUIPPED WITH RESIN CAPSULE AND METHOD OF OPERATING SAID APPARATUS

(71) Applicant: PLANMECA OY, Helsinki (FI)

(72) Inventors: Jukka KANERVA, Helsinki (FI); Samppa DRAVANTTI, Helsinki (FI); Tero RAKKOLAINEN, Helsinki (FI)

(21) Appl. No.: 17/256,281

(22) PCT Filed: Mar. 11, 2019
(86) PCT No.: PCT/FI2019/050198

§ 371 Date: Dec. 28, 2020

(30) Foreign Application Priority Data
Jun. 28, 2018 (FI) 20185585

(51) Int. Cl. B29C 64/124; B29C 64/259; B29C 64/245; B29C 64/232; B29C 64/205; B33Y 10/00; B33Y 30/00

(52) U.S. Cl. CPC B29C 64/124; B29C 64/259; B29C 64/245; B33Y 30/00; B29C 64/205; B33Y 10/00; B29C 64/232

(57) ABSTRACT

Stereolithography apparatus comprising a vat (401) for holding resin during stereolithographic 3D printing, a resin delivery mechanism (701) comprising at least one resin tank and a holder (602) for removably receiving the resin tank in the stereo-lithography apparatus, wherein the resin tank is a resin capsule (501) for holding a single shot of resin (703) arranged to be emptied to the vat (401).

### FIELD OF THE INVENTION

The invention concerns the technology of stereolithographic 3D printing, also known as stereolithographic additive manufacturing. In particular the invention concerns the task of providing a specific amount of resin to a vat.

### BACKGROUND OF THE INVENTION

Stereolithography is a 3D printing or additive manufacturing technique in which optical radiation is used to photopolymerize suitable raw material to produce the desired object. The raw material comes to the process in the form of a resin. A vat is used to hold an amount of resin, and a build platform is moved in the vertical direction so that the object to be produced grows layer by layer, beginning on a build surface of the build platform. The optical radiation used for photopolymerizing may come from above the vat, in which case the build platform moves downwards through the remaining resin as the manufacturing proceeds. The present description concerns in particular the so-called “bottom up” variant of stereolithography, in which the photopolymerizing optical radiation comes from below the vat and the build platform moves upwards away from the remaining resin as the manufacturing proceeds.

The resin is held in a container and the user estimates the amount of resin to dispense from the container to the vat. The container may be portable (e.g. bottle) and the user pours the resin to the vat. However, it is difficult to estimate the amount of resin that is poured and the user easily pours too much resin and the additional resin is lost. As the resins are relatively expensive, care should be taken to not allow too much resin to enter the vat and to utilize as much of the remaining resin as possible for actual manufacturing jobs. If the user pours too little resin, the desired object will be incomplete or the printing process is interrupted. Pouring may also be messy and the resin may even be spilled out of the vat.

The resin container may also be large fixed tank from which the resin is conducted to the vat by a separate channel. Different resins are needed for manufacturing different kinds of objects and large resin tanks are unconventional because one resin material is very difficult to replace with another resin material.

The whole resin tank and the resin channel must be cleaned carefully before starting a new process with the new resin material. If some previous resin material is left inside the tank or channel, it could lead to undesired result.

### OBJECTIVE OF THE INVENTION

An objective of the invention is to enable a convenient and economical handling of resins for stereolithographic 3D printing.

### SUMMARY

The invention is aimed to present a stereolithography apparatus and a method of operating a stereolithography apparatus enabling economical handling of resins for stereolithographic 3D printing.

These and other advantageous aims are achieved by equipping the stereolithography apparatus with a resin capsule disclosing a single shot of resin to be used.

According to a first aspect, a stereolithography apparatus comprises a resin delivery mechanism comprising a holder for removably receiving at least one resin tank. The resin tank is a resin capsule for holding a single shot of resin arranged to be emptied, wherein the single shot of resin is an amount of resin needed for single printing process.

According to another aspect, a resin delivery mechanism comprises at least one holder for removably receiving at least one resin tank and wherein the resin tank is at least resin capsule for holding a single shot of resin arranged to be emptied for a single printing process, and wherein the single shot of resin in said at least one resin capsule is an amount of resin needed for said single printing process.

According to another aspect, the single shot of resin is arranged to be emptied from the at least one resin capsule to a vat arranged for holding resin during a stereolithographic 3D printing process.

In an embodiment of the stereolithography apparatus, the apparatus comprises a vat for holding resin during stereolithographic 3D printing and whereto the resin from the resin capsule is arranged to be emptied.

In an embodiment, the stereolithography apparatus comprises a piston arranged to empty the resin from the resin capsule into the vat.

In an embodiment, the resin capsule is disposable.

In an embodiment of the stereolithography apparatus, the resin capsule is located above the vat whereby the resin is injected straight to the vat.

In an embodiment of the stereolithography apparatus, the vat comprises at least one channel arranged to receive the resin from the resin capsule.

In an embodiment of the stereolithography apparatus, the holder comprises adjustable clamps whereby the holder is able to receive and hold resin capsules with different sizes.

In an embodiment of the stereolithography apparatus, it comprises a build platform mechanism arranged to move in vertical direction during the stereolithography process.

In an embodiment of the stereolithography apparatus, the piston is connected to the build platform mechanism whereby the piston and the build platform mechanism move in concert.

In an embodiment of the stereolithography apparatus, the piston is arranged to be pulled back, whereby a vacuum is formed inside the resin capsule and resin is drained back inside the resin capsule.

In an embodiment of the stereolithography apparatus, the apparatus comprises two or more holders (602) for receiving resin capsules holding a single shot of resin.

In an embodiment of the stereolithography apparatus, the apparatus comprises at least one resin tank, wherein the resin tank is a resin capsule.

According to a second aspect, a method of operating a stereolithography apparatus comprises steps of:
receiving data of the object design,
defining the needed amount of resin and size of the resin capsule for the single printing process by using the received data of the object design,
fastening the resin capsule to the holder,
emptying the resin capsule, holding a single shot of resin, into the vat.

In an embodiment, two or more resin capsules are fastened to at least one holder, and each of the resin capsules, holding a single shot of resin, are emptied at the beginning of single printing process.

According to another aspect, a method of operating a stereolithography apparatus comprises steps of:— receiving data of a printing design,
defining the needed amount of resin for a single printing process by using received data of the printing design,
fastening at least one resin capsule to at least one holder,
emptying the at least one resin capsule, holding said single shot of resin, to a vat.

The method may comprise using at least two resin capsules with a single shot of resin which are emptied in connection with the manufacturing a single printing design.

According to another aspect, regardless if one or more capsules are used, the capsule or the capsules are emptied as a single shot at the onset of the printing process, prior to an actual additive manufacturing process commences.

In an embodiment of the method of operating a stereolithography apparatus, the resin capsule is emptied by a movement of a piston.

In an embodiment of the method of operating a stereolithography apparatus, it further comprises a step of forming a vacuum inside the resin capsule by pulling the piston back, and draining the resin back inside the resin capsule.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a stereolithography apparatus in a front view with its lid closed,

FIG. 2 illustrates a stereolithography apparatus in a side view with its lid closed,

FIG. 3 illustrates a stereolithography apparatus in a front view with its lid open,

FIG. 4 illustrates a stereolithography apparatus in a side view with its lid open,

FIG. 5 illustrates a stereolithography apparatus,

FIG. 6 illustrates a stereolithography apparatus in a front view,

FIG. 7 illustrates a resin delivery mechanism,

FIG. 8 illustrates a stereolithography apparatus without a resin capsule, and

FIG. 9 illustrates a stereolithography apparatus with the resin capsule in a front view.

### DETAILED DESCRIPTION

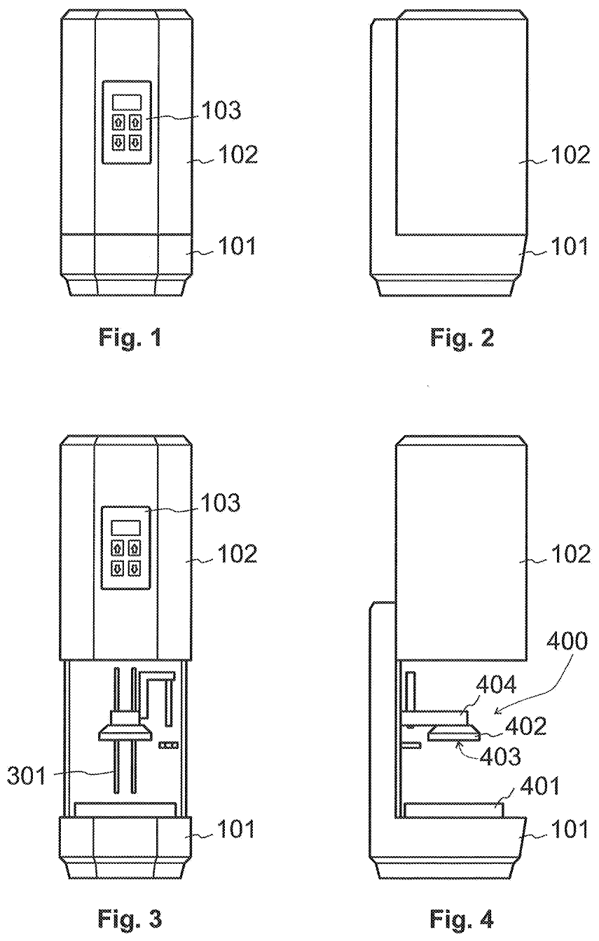

FIGS. 1 to 4 illustrate an example of a stereolithography apparatus. The apparatus could also be called a stereolithographic 3D printer, or a stereolithographic additive manufacturing apparatus. Basic parts of the apparatus are a base part 101 and a lid 102, of which the lid 102 is movably coupled to the base part 101 so that it can move between a closed position shown in FIGS. 1 and 2 and an open position shown in FIGS. 3 and 4. Here the direction of the movement is vertical, but this is not a requirement; the movement of the lid 102 in relation to the base part 101 could take place in other directions. An important advantage of a movable lid of this kind is that an ongoing stereolithographic 3D printing process can be protected from any interfering external optical radiation by closing the lid 102.

A vat 401 is provided in the base part 101 for holding resin for use in the stereolithographic 3D printing process. A build platform 402 with a build surface 403 is supported above the vat 401 so that the build surface 403 faces the vat 401. This arrangement is typical to the so-called “bottom up” variant of stereolithography, in which the photopolymerizing radiation comes from below the vat. The bottom of the vat 401 is or can be selectively made transparent or translucent for the kind of radiation used for said photopolymerizing.

A stereolithography apparatus may be provided as equipped with e.g. a holder for releasable connection of the vat to the apparatus.

A moving mechanism is provided and configured to move the build platform 402 in a working movement range between first and second extreme positions. Of these, the first extreme position is the one proximal to the vat 401, and the second extreme position is the one distant from the vat 401. In the first extreme position the build surface 403 is very close to the bottom of the vat 401. The first layer of the object to be manufactured will be photopolymerized onto the build surface 403 when the build platform 402 is in the first extreme position. Consequently, in said first extreme position the distance between the build surface 403 and the bottom of the vat 401 is in the order of the thickness of one layer in the stereolithographic 3D printing process.

The position shown in FIGS. 3 and 4 may be the second extreme position, or at least closer to the second extreme position than to the first extreme position. A working region of the stereolithography apparatus may be said to exist between the vat 401 and the second extreme position of the build platform 402, because the object to be manufactured will appear within this region. The build platform 402 does not need to move up to or even close to the second extreme position during the manufacturing of an object; the second extreme position may be most useful for making it easier to detach a manufactured object from the build platform 402 once the object is complete.

In the embodiment of FIGS. 1 to 4 the moving mechanism for moving the build platform 402 is inside the base part 101, and only represented by the two slits 301 seen in a vertical surface of the base part 101, as well as the horizontal support 404 of the build platform 402. There is also a similarly hidden moving mechanism for moving the lid 102 with respect to the base part 101. This second moving mechanism may comprise parts inside the base part 101 and/or parts inside the lid 102. Enclosing essentially all moving mechanisms within the casings of the base part 101 and/or the lid 102 involves the advantage of added safety, because it makes it improbable that a user could get injured by any moving parts of such mechanisms.

The horizontal support 404 of the build platform 402 is shown only schematically in the drawings. In a practical implementation a support of the build platform 402 may comprise various advanced technical features, like joints and/or fine tuning mechanisms for ensuring that the orientation of the build surface 403 is appropriate. However, such features are out of the scope of this description and are therefore omitted here.

Another feature of the exemplary stereolithography apparatus of FIGS. 1 to 4 is a user interface, which comprises a touch-sensitive display 103 in the lid 102. The user interface may comprise various functions for implementing interactions between the apparatus and its user, including but not being limited to buttons for controlling the movements of the lid 102 and the build platform 402. A touch-sensitive display is an advantageous feature of a user interface in particular if the stereolithography apparatus is to be used in environments where thorough cleaning and disinfecting are regularly required, like at medical and/or dental clinics. Placing a touch-sensitive display 103 and/or other parts of the user interface in a front part of the lid 102 is advantageous, because it makes such parts of the user interface easily accessible to the user. As such, at least some parts of the user interface could be implemented in the base part 101. The touch-sensitive display 103 may be used for receiving information of the object design and the resin. It may be also used for inputting needed parameters (e.g. properties of the resin) for the printing process.

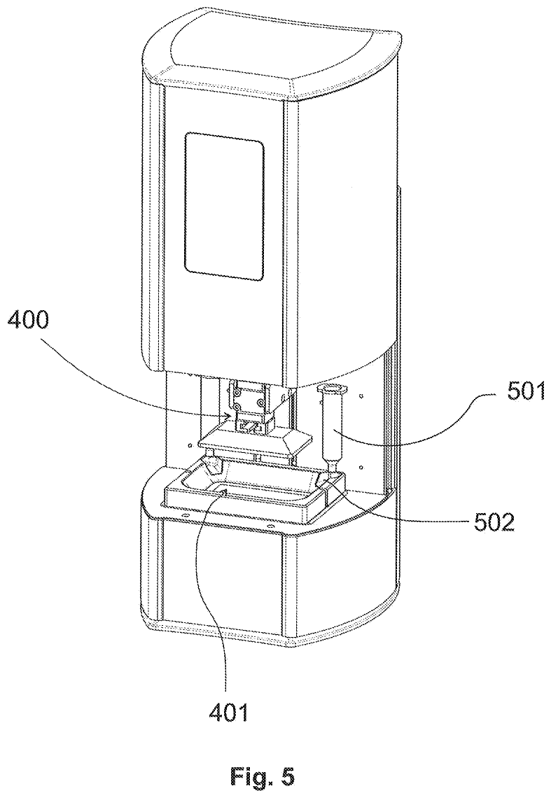

The resin that is to be used in the stereolithographic 3D printing process may be brought to the stereolithography apparatus in a resin tank. The designation “resin tank” is used in this text as a general descriptor of any kinds of containers that may hold resin in readiness for the resin to be used in a stereolithographic 3D printing process. FIG. 5 illustrates an example of a stereolithography apparatus having the lid 102 in the open position. The resin tank is provided in form of a resin capsule 501, which contains one single shot of resin that is needed for a single stereolithographic 3D printing process. The needed amount of resin depends on the object to be printed and, therefore, the size of the resin capsule 501 may vary. The needed amount of resin may be calculated by the user or the stereolithography apparatus may have means to calculate the amount based on the object design. After calculating the needed amount of resin, the stereolithography apparatus may suggest the resin capsule to be used. The resin capsule 501 is located above the vat 401 so that the resin may be emptied from the resin capsule 501 straight into the vat 401, which prevents unnecessary spillage.

According to one embodiment, the vat 401 comprises a channel that is arranged to receive the resin from the resin capsule. In FIG. 5, the channel 502 is located below the resin capsule 501 in the corner of the vat 401. The channel may be a groove or a tube which conducts the resin further into the vat 401. The vat 401 may comprises several channels so that one is located below each resin capsule.

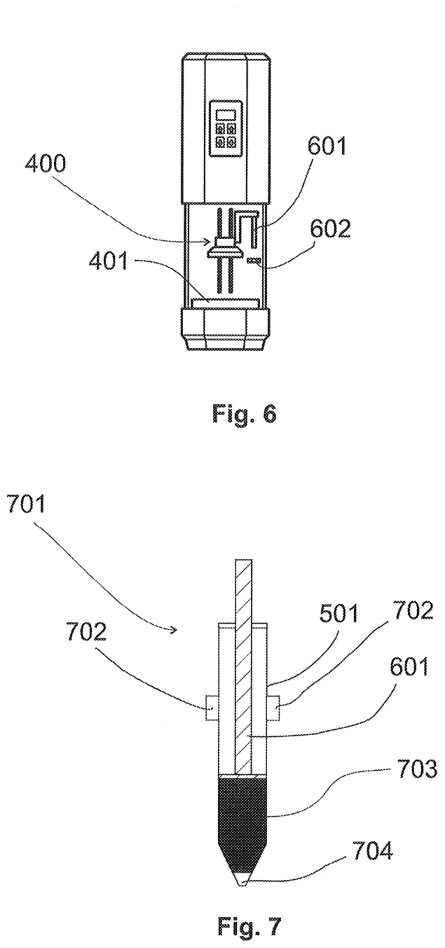

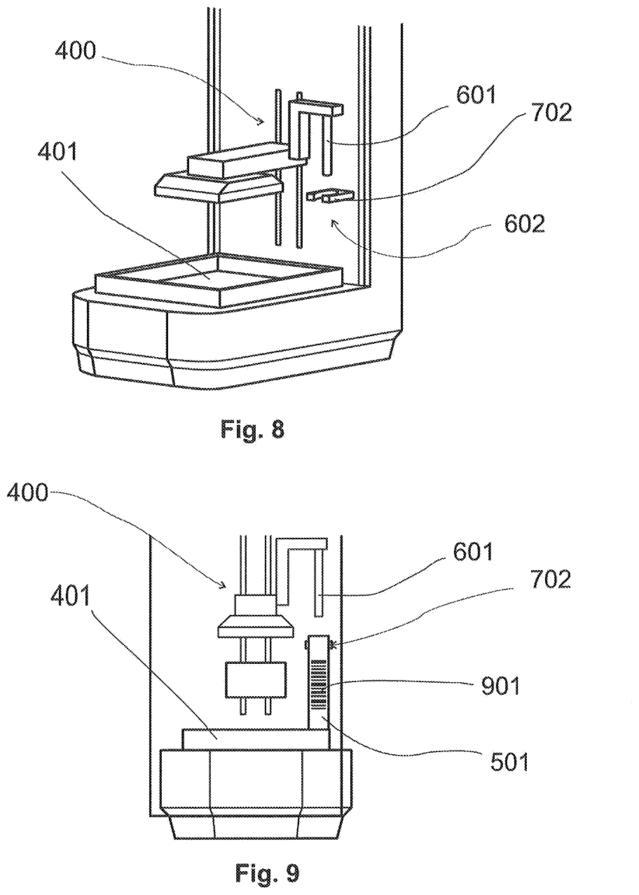

The stereolithography apparatus may comprise a holder for removably receiving a resin capsule to an operating position in the stereolithography apparatus. An example of such a holder is illustrated in FIGS. 6 and 8 with the reference designator 602. Providing a holder for removably receiving a resin capsule involves the advantage that the user may easily exchange resin capsules to ensure the use of the most optimal resin for each stereolithographic 3D printing job.

A resin capsule that can be removably received in the holder 602 may have the form of an elongated capsule, as in figures, preferably with a cover or plug covering an opening in one end, and with an outlet 704 appearing in the other end. The outlet 704 may be equipped with a valve, seal, plug, or some other means that keep the resin from escaping the resin capsule unless explicitly desired. Such an elongated resin capsule can be removably received in the holder 602 so that the end with the opening is upwards, and the outlet 704 is in or close to the vat 401.

In the example embodiment of FIGS. 6 and 8 a piston 601 is attached to the same support 404 as the build platform 402. When the build platform 402 moves downwards in order to assume the first extreme position, which is the starting position for producing a new object, the piston 601 moves downwards in concert with the build platform 402. This movement of the piston 601 pumps the resin out of the resin capsule that was received in the holder 602, so that the resin flows out of the outlet 704 and into the vat 401. The cover or plug that covered the opening in the upper end of the resin capsule must naturally have been removed before that, as well as the means that closed the outlet 704 unless some mechanism is provided that automatically opens the outlet when needed.

It must be noted that making the piston 601 move in concert with the build platform 402 is only an example implementation. It involves the advantage that only one moving mechanism is needed to move two parts. However, in some applications it may be desirable to be able to control the delivery of resin to the vat 401 independently of the movement of the build platform 402. For such applications an embodiment can be presented in which there are separate mechanisms for moving the build platform 402 and for delivering resin from a resin capsule into the vat 401. Such a separate mechanism may involve for example a piston that is otherwise like the piston 601 in FIG. 6 but supported and moved by a moving mechanism of its own.

Figures comprise only examples of the piston design. It is understood that the piston may have different shapes and structures as far as it works in its purpose and is suitable to empty the resin out of the resin capsule 501.

Only one holder 602 for one resin capsule is shown in the drawings, but the stereolithography apparatus may comprise two or more holders, and/or a single holder may be configured to receive two or more resin capsules. In particular if there are separate mechanisms for pumping resin from different resin capsules to the vat 401, the provision of places for receiving multiple resin capsules involves the advantage that different resins can be used automatically, even during the manufacturing of a single object. Such a feature may be useful for example if the object to be manufactured should exhibit a sliding change of color. The stereolithography apparatus might comprise two resin capsules of differently pigmented resin, and these could be delivered to the vat in selected proportions so that the resulting mix of resins in the vat would change its color accordingly.

According to one aspect, there may be e.g. just single size capsules and the amount of resin to be fed can be adjusted based on the number of the single size capsules used in connection with a single printing process.

According to one embodiment, the holder 602 comprises adjustable clasps 702 that may be adjusted to receive resin capsules with different sizes and shapes.

FIG. 7 illustrates a resin delivery mechanism 701 comprising a resin capsule 501 having some resin 703 inside. The resin capsule is held by the adjustable clasps 702 that retain the resin capsule from its sides. The resin delivery mechanism comprises also a piston 601 arranged to move up and down. The downwards movement pumps the resin 703 out of the resin capsule so that the resin flows out of the outlet 704 and to the vat 401.

According to an embodiment, the resin capsule 501 is disposable so that after single use, the resin capsule is replaced by a new one.

As the resin is relatively expensive, it is not economical to waste the resin that is left over after the printing process. Therefore, according to one embodiment, the upwards movement causes a vacuum inside the resin capsule 501 and the resin from the vat 401 may be drained back into the resin capsule 501 and used again later. The vacuum is achieved by sealing the piston air tightly against the inner wall of the resin capsule. As the piston is pulled back up, a vacuum is formed inside the resin capsule between the piston 601 and the outlet 704. The resin capsule is located so that the outlet is at the proximity of the vat and it is able to reach the resin on the vat. After the printing process, the extra resin is drained back inside the resin capsule for later use.

According to an embodiment, the vat 401 may be inclined towards the resin capsule. In this inclined position, the extra resin is flown towards the outlet of the resin capsule and the extra resin may be collected more efficiently.

FIG. 9 illustrates schematically a case in which a resin capsule 501 has been received in the holder 702. The resin capsule 501 may comprise an identifier (e.g. graphical or electronical) having information regarding the resin, contained in that particular resin capsule 501, or the resin capsule 501 itself. Said information may contain for example one or more of the following: an identifier of resin contained in the resin capsule 501, an indicator of amount of resin contained in the resin capsule, a manufacturing date of resin contained in the resin capsule 501, a best before date of resin contained in the resin capsule, unique identifier of the resin capsule 501, a digital signature of a provider of resin contained in the resin capsule 501. Said information may be used for controlling the stereolithography apparatus. For example the identifier may contain information of the size of the resin capsule 501 and said information is used to define the movement of the piston 601 when pumping the resin out of the resin capsule 501 or when draining the left over resin back inside the resin capsule 501.

It is obvious to a person skilled in the art that with the advancement of technology, the basic idea of the invention may be implemented in various ways. The invention and its embodiments are thus not limited to the examples described above, instead they may vary within the scope of the claims.

1. Stereolithography apparatus, comprising:
a resin delivery mechanism comprising at least one holder for removably receiving at least one resin tank, wherein
the resin tank is at least resin capsule for holding a single shot of resin arranged to be emptied for a single printing process, wherein the single shot of resin in said at least one resin capsule is an amount of resin needed for said single printing process.

2. A stereolithography apparatus according to claim 1, wherein the single shot of resin is arranged to be emptied from the at least one resin capsule to a vat arranged for holding resin during a stereolithographic 3D printing process.

3. A stereolithography apparatus according to claim 2, comprising a piston arranged to empty the resin from the resin capsule into the vat.

4. A stereolithography apparatus according to claim 1, wherein the resin capsule is disposable.

5. A stereolithography apparatus according to claim 2, wherein the resin capsule is located above the vat whereby the resin is injected straight to the vat.

6. A stereolithography apparatus according to claim 2, wherein the vat comprises at least one channel arranged to receive the resin from the resin capsule.

7. A stereolithography apparatus according to claim 1, wherein the holder comprises adjustable clamps whereby the holder is able to receive and hold resin capsules of different sizes.

8. A stereolithography apparatus according to claim 1, comprising a build platform mechanism arranged to move in vertical direction during the stereolithography process.

9. A stereolithography apparatus according to claim 8, wherein the piston is connected to the build platform mechanism whereby the piston and the build platform mechanism move in concert.

10. A stereolithography apparatus according to claim 3, wherein the piston is arranged to be pulled back, whereby a vacuum is formed inside the resin capsule and resin is drained back inside the resin capsule.

11. A stereolithography apparatus according to claim 1, wherein the apparatus comprises two or more holders for receiving resin capsules holding a single shot of resin.

12. A stereolithography apparatus according to claim 1, wherein the apparatus comprises at least one resin tank, wherein the resin tank is a resin capsule.

13. A method of operating a stereolithography apparatus according to claim 1, comprising steps of:
receiving data of a printing design,
defining the needed amount of resin for the single printing process by using the received data of the printing design,
fastening the at least one resin capsule the at least one holder,
emptying the at least one resin capsule, holding said single shot of resin, into the vat.

14. A method of operating a stereolithography apparatus according to claim 13, wherein two or more resin capsules are fastened to at least one holder, and each of the resin capsules is emptied in connection with manufacturing the single printing design.

15. A method of operating a stereolithography apparatus according to claim 13, wherein the resin capsule is emptied by a movement of a piston.

16. A method of operating a stereolithography apparatus according to claim 13, further comprising a step of forming a vacuum inside the resin capsule by pulling the piston back, and draining the resin back inside the resin capsule after completion of the printing process.
